(19) United States
(12) Patent Application Publication
(10) Pub. No.: US 2025/0324254 A1
(43) Pub. Date: Oct. 16, 2025

(54) Managing a Virtual Access Point in a Wireless Network

(71) Applicant: Comcast Cable Communications, LLC, Philadelphia, PA (US)

(72) Inventors: Soumya Munshi, Campbell, CA (US); Anil Katragadda, Downingtown, PA (US); Sanjay Dwivedi, Philadelphia, PA (US); Prashanth Kondedath, San Jose, CA (US)

(21) Appl. No.: 18/631,486

(22) Filed: Apr. 10, 2024

(51) Int. Cl. H04W 12/08; H04W 8/24

(52) U.S. Cl. CPC H04W 12/08; H04W 8/24

(57) ABSTRACT

An access point may create a virtual access point based on a connection request message from a wireless device. The wireless device may communicate with a computing device via the virtual access point. The computing device may send information about the access point to the wireless device. The wireless device may connect to the access point, for example, using the information.

### BACKGROUND

Creating dedicated wireless access points for onboarding may deplete resources. Using the same wireless access point for both onboarding and services may pose security risks and reduce airtime efficiency. Having multiple access points for onboarding may result in inefficient airtime utilization, causing interference, beacon pollution, and a negative impact on overall performance, diverting resources from other services. The following disclosure discusses, among other things, new and improved ways to address these issues.

### SUMMARY

The following summary presents a simplified summary of certain features. The summary is not an extensive overview and is not intended to identify key or critical elements.

Systems, apparatuses, and methods are described for dynamically creating a virtual access point to onboard and provision a wireless device in a wireless network. A wireless device (e.g., Wi-Fi extender, security camera, etc.) may send a message to an access point to request joining a wireless network. Based on the message from the wireless device, the access point may create a virtual access point dedicated to the wireless device. After connecting to the virtual access point, the wireless device may communicate with a computing device (e.g., a cloud server) via the virtual access point. The computing device may send information associated with the access point to the wireless device. Using the information, the wireless device may join the wireless network of the access point. After establishing a successful connection with the wireless device, the access point may destroy the virtual access point.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 is a block diagram depicting an example architecture of a system consistent with aspects of the disclosure.

FIG. 4 is a sequence diagram depicting an example protocol to onboarding and provisioning a wireless access point using an access point, a virtual access point, and a computing device.

FIG. 5 is a flowchart depicting an example method for an access point to manage a virtual access point according to aspects of the disclosure.

FIG. 6 is a flowchart depicting an example method of connecting a device to access points according to aspects of the disclosure.

FIG. 7 is a flowchart depicting an example method for a computing device to onboard and provision a wireless device according to aspects of the disclosure.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

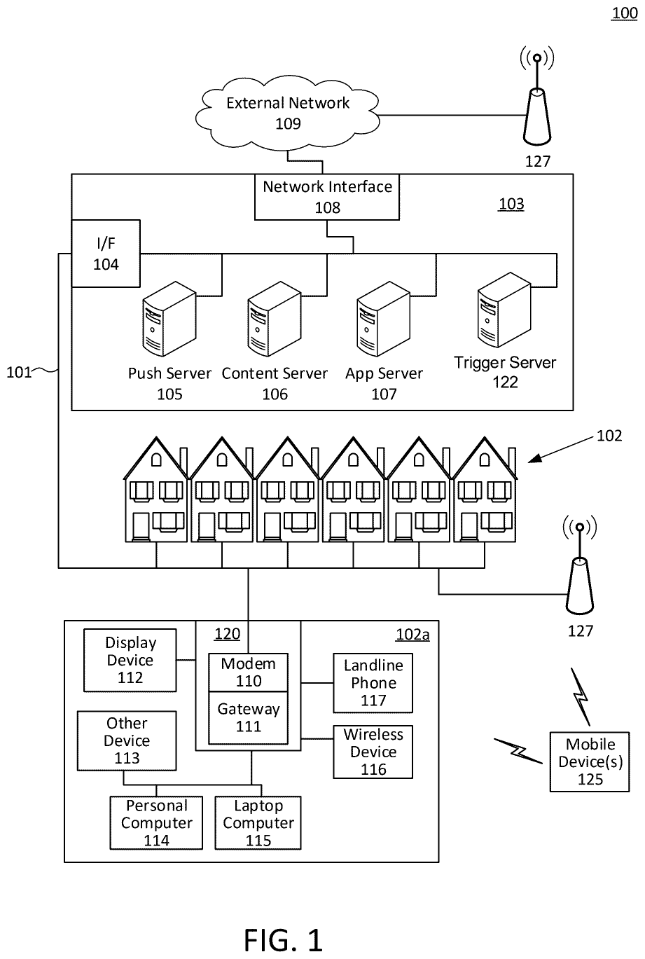

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a Wi-Fi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the trigger server 122 (described below), additional push, content, and/or application servers, and/or other types of servers. Although shown separately, the push server 105, the content server 106, the application server 107, the trigger server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

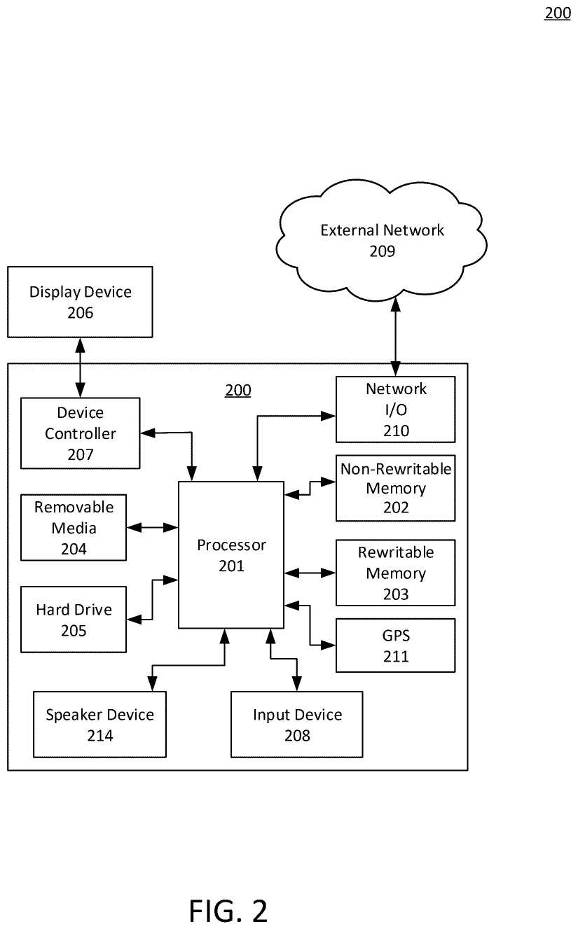

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein. The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

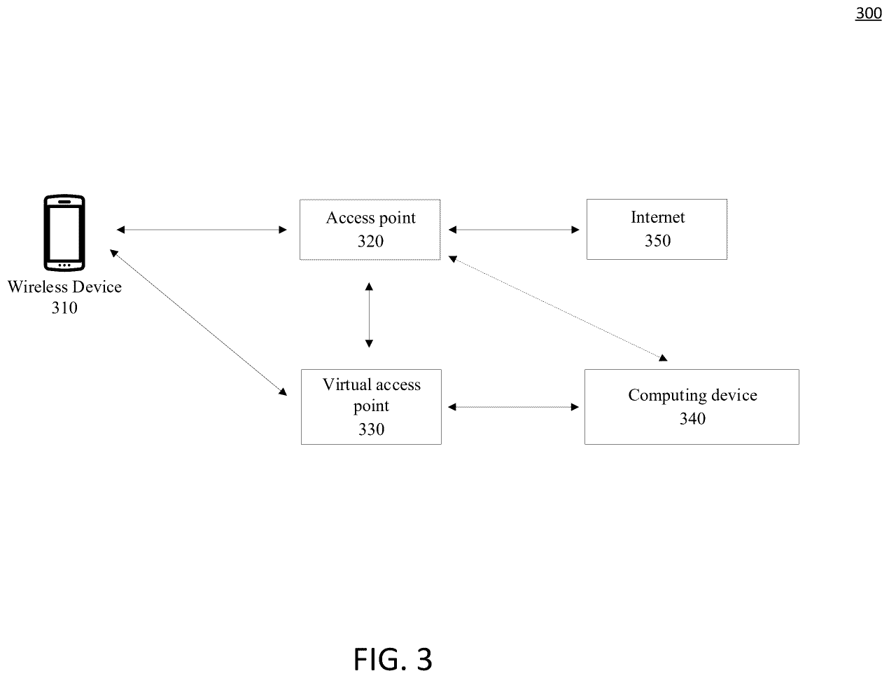

FIG. 3 is a block diagram depicting an example system 300 that can be used for onboarding and/or provisioning in a wireless network according to various embodiments of the disclosure. As shown in FIG. 3, system 300 may include at least one wireless device (e.g., wireless device 310), an access point 320, a virtual access point 330, and one or more computing devices 340 (e.g., server), and internet 350. For ease of explanation, the system 300 has been shown with only one of each of the wireless device 3102, access point 320, virtual access point 330, computing device 340, and internet 350, but it should be understood that the system 300 may contain any appropriate number of any of these components.

According to various embodiments, a wireless device 310 may comprise one or more of a mobile station, Wi-Fi extender, or security camera, etc., to name a few non-limiting examples. Additionally, the wireless device 310 may connect to one or more networks via the access point 320. For example, in some embodiments, the wireless access point 320 may comprise an access point/router for a home Wi-Fi network, multiple access points placed to provide Wi-Fi coverage across the entire space for business/office network, wireless access points installed for public Wi-Fi access, access points for educational institutions, or any other access points for any other purposes. As such, the wireless device 310 may connect to the access point 320 using the 802.11 protocols (e.g., 802.11a, 802.11b, 802.11g, 802.11n, 802.11ac, 802.11ax, etc.) or Bluetooth protocols (e.g., Bluetooth 4.0, Bluetooth 5.0, Bluetooth 5.1, etc.).

As described herein, the computing device 340 may send, to the access point 320, a configuration information. The configuration information may comprise at least one type of at least one wireless device. The access point 320 may create the virtual access point 330 corresponding to the wireless device 310, based on the type of the wireless device 310. Furthermore, the configuration information may further comprise information relating to parameters of a virtual access point 330. The information may comprise at least one SSID, at least one password, at least one parameter relating to wireless network security, and/or any other information of at least one virtual access point. Additionally or alternatively, the configuration information may comprise MAC addresses of wireless devices. The access point 320 may use the MAC addresses of wireless devices, for example, to filter incoming messages from the wireless devices.

Additionally or alternatively, in some embodiments, the computing device 340 may send, to the access point 320, a configuration information comprising at least one SSID of at least one virtual access point. A wireless device may be pre-configured to know an SSID and/or a pre-set (or built-in) password for the SSID of a virtual access point. For example, the wireless device 310 already knows the SSID and/or the password of the virtual access point 330. The wireless device 310 may send, to the wireless access point 320, a message comprising the SSID of the virtual access point 330. Upon receiving the message from the wireless device 310, the access point 320 may determine whether the SSID contained in the message corresponds to one of the SSIDs sent by the computing device 340. The access point 320 may create the virtual access point 330 dedicated to the wireless device 310 if the SSID contained in the message corresponds to one of the SSIDs sent by the computing device 340.

Optionally, the configuration information sent by the computing device 340 may comprise at least one MAC address of at least one wireless device. For example, the computing device 340 may send, to the access point 320, configuration information comprising the MAC address of the wireless device 310. The wireless device 310 may send, to the access point 320, a message (e.g., a probe request message 403) comprising the MAC address of the wireless device 310. If the MAC address contained in the message does not correspond to one of the MAC addresses that may have been sent by the computing device 340, the access point 320 rejects the wireless device 310 to connect to the virtual access point 330 and/or does not create any virtual access point for the wireless device 310.

The wireless device 310 may send, to the access point 320, a message to request to join a wireless network. The message may comprise, for example, the type of the wireless device 310, a MAC address of the wireless device 310, and/or any other information. Based on the received message from the wireless device 310, the access point 320 may determine whether to create the virtual access point 330 for the wireless device 310.

Some methods for onboarding wireless devices onto Wi-Fi 802.11 network may involve manual (or human) interventions such as scanning quick response (QR) codes, typing serial numbers of a wireless device, and/or logging on the wireless device's web page. Furthermore, using the same access point not only for onboarding/provisioning but also for actual services may increase a vulnerability where security could be compromised. For example, if an attacker gains access to the Wi-Fi network during the onboarding process, sensitive information could be eavesdropped or hacked. To address these security flaws, there may be a need for improved onboarding process that may minimize the risk of unauthorized access. In addition, having multiple access points for only onboarding/provisioning purposes may contribute to inefficient airtime utilization, which could have been allocated to other services. This approach may create interference and/or negatively impact the overall performance of the network. Therefore, a more streamlined and secure onboarding/provisioning strategy may be needed to optimize resource usage and/or enhance network efficiency.

As described herein, an access point may dynamically create a virtual access point, for example, based on the type of wireless device that may be onboarded and provisioned. For example, if a wireless device (e.g., a Wi-Fi extender or a security device) powers on, the wireless device may send a message, to an access point, to be onboarded. The message may comprise the type of the wireless device. The access point may receive the message and dynamically create a virtual access point dedicated to the wireless device, for example, based on the type of the wireless device. Upon being created, the virtual access point may send, to the wireless device, a response message indicating that the wireless device is connected to the virtual access point. The wireless device may connect to a computing device (e.g., a cloud server) via the virtual access point. The wireless device may send, to the computing device, information relating to at least one parameter of the wireless device. Based on the information, the computing device may send, to the wireless device, for example, a password of the access point. Using the password, the wireless access may be able to connect to the access point. After successful connecting to the wireless device, the access point may destroy the virtual access point. By creating the virtual access point dedicated to the wireless device, a secure and efficient onboarding/provisioning process may be ensured.

As described herein, a wireless device may send, to an access point, a message. The message may comprise information relating to parameters of the wireless device. The parameters may encompass a variety of details associated with the device's capabilities, settings, and/or requirements for connecting to a wireless network. For example, the parameters may include a type (e.g., smartphone, laptop, tablet, IoT device, Wi-Fi extender, security camera, etc.), manufacturer (e.g., Comcast, Samsung, Apple, etc.), model (e.g., the specific model and/or version of the wireless device), MAC address (or any unique identifier assigned to the wireless device for network identification and access control), supported Wi-Fi standards (e.g., 802.11b/g/n/ac/ax, etc.), operating system and version (e.g., Android, IOS, Windows, Linux, along with the specific version or release), connectivity settings (e.g., details such as IP address settings (static or DHCP), subnet mask, gateway, DNS servers, etc.), security capabilities (e.g., information on encryption methods like WEP, WPA2, WPA3, etc., and/or authentication protocols for secure network access and data transmission), preferred network list (e.g., a list of known or preferred Wi-Fi networks saved on the device, possibly with associated security credentials, etc.), channel and frequency band (e.g., the Wi-Fi channel and frequency (e.g., 2.4 GHz, 5 GHZ, 6 GHz, etc.) the device uses or prefers for the connection), and/or any other pertinent information of the wireless device.

The type (or class) of wireless devices may be based on a plurality of criteria, without limitation. For example, the types of wireless devices may be categorized based on functionality. The types of wireless devices may comprise mobile devices with wireless communication capabilities (e.g., smartphones, tablets), devices used for monitoring and collecting data (e.g., wireless sensors), wearable devices (e.g., smartwatches, fitness trackers, and wireless earbuds). The types of wireless devices may be classified, for example, based on the connectivity standard (e.g., Wi-Fi, Bluetooth, Zigbee, or cellular devices). Furthermore, the types of wireless devices may be distinguished based on their application, such as security cameras, home automation devices (e.g., smart thermostats, smart locks, smart lights), or health monitoring devices (e.g., blood pressure monitors, glucose monitors, wearable health trackers). Additionally, the types of wireless devices may be, for example, based on the operating environment, with categories including indoor devices (e.g., indoor security cameras, smart home devices, Wi-Fi routers) or outdoor devices (e.g., outdoor Wi-Fi access points, drones, agricultural sensors), which may be designed to withstand various weather conditions. The types of wireless devices may be further classified without limitation.

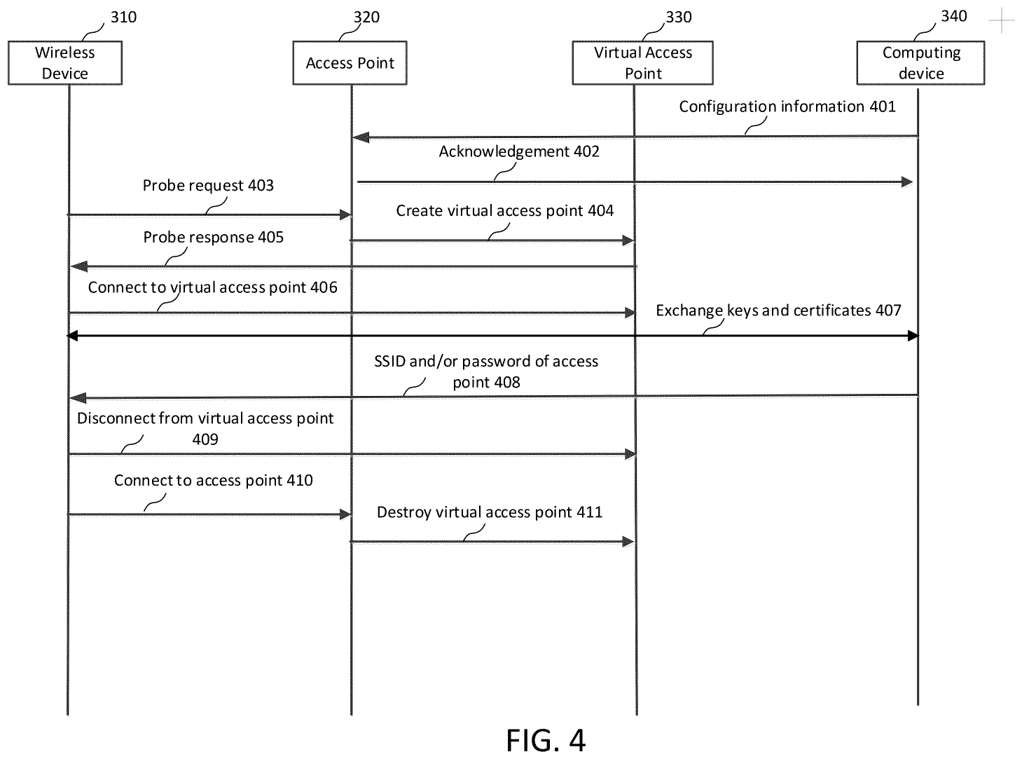

FIG. 4 is a sequence diagram depicting an example protocol to onboarding and provisioning a wireless access point using an access point, a virtual access point, and a computing device. As depicted in the sequence diagram of FIG. 4, a computing device 340 (e.g., a cloud server) may send a configuration information message 401 to an access point 320.

The computing device 340 may inform the access point 320 that a certain type of wireless device may correspond to a specific virtual access point. For example, a type 1 wireless device corresponds to virtual access point 1, a type 2 wireless device corresponds to virtual access point 2, . . . , and a type N wireless device corresponds to virtual access point N. Each virtual access point may have its own SSID. For example, virtual access point 1 has SSID 1, virtual access point 2 has SSID 2, . . . , virtual access point N has SSID N.

The configuration information message 401 may comprise at least one SSID of a virtual access point associated with a type of wireless device. The configuration information message 401 may further comprise a password for the at least one SSID.

Additionally, the configuration information message 401 may further comprise at least one parameter relating to wireless network security (e.g., key management methods, encryption algorithms, authentication mechanisms, and/or any other security-related parameters) associated with the virtual access point 330. For example, the access point 320 may use the at least one parameter, for example, to enhance the safety and security of the virtual access point (e.g., virtual access point 330).

In some embodiments, the configuration information message 401 may comprise at least one media access control (MAC) address of at least one wireless device (e.g., wireless device 310). The access point 320 may use the at least one MAC address, for example, to either reject or allow at least one wireless device to connect.

As shown in FIG. 4, upon receiving the configuration information 401, the access point 320 may send an acknowledgement message 402 to the computing device 340. According to some embodiments, the acknowledgement message 402 may take the form of acknowledgment frames. For example, the acknowledgment frames may be used to confirm the successful receipt of the configuration information message 401. In IEEE 802.11 standard, which defines the specifications for Wi-Fi networks, acknowledgment frames are designed for confirming the successful receipt of a data frame. For example, if a Wi-Fi enabled device successfully receives a data frame from a sender, the Wi-Fi enabled device sends an acknowledgment message back to the sender.

In some embodiments, a wireless device (e.g., a Wi-Fi-enabled device) may send a message (e.g., a probe request message) to discover and/or gather information about available Wi-Fi networks in the vicinity. The probe request message may comprise any information that helps an access point to understand the identity and/or the requirements of the wireless device. For example, as described with respect to FIG. 4, the wireless device 310 may send, to the access point 320, a probe request message 403. The probe request message 403 may comprise, for example, the type of the wireless device 310. Additionally or alternatively, the probe request message 403 may comprise, for example, a MAC address of the wireless device 310, and/or any other information associated with the wireless device 310.

As depicted in the sequence diagram of FIG. 4, the access point 320 may receive the probe request message 403. The probe request message 403 may comprise the type (e.g., Wi-Fi extender, or security camera, etc.) of the wireless device 310. The access point 320 may create, based on the type of the wireless device 310, the virtual access point 330 corresponding to the wireless device 310.

Additionally, the probe request message 403 may further comprise information relating to the security capabilities (e.g., supported encryption and/or authentication methods) of the wireless device 310. Upon receiving the probe request message 403, which comprises the type and security capabilities of the wireless device 310, the access point 320 may assess the type of the wireless device 310 and determine whether the wireless device 310 has any security risks. For example, Internet of Things (IoT) devices may be considered higher risk due to factors such as less frequent updates and/or inherent vulnerabilities. The access point 320 may evaluate the security capabilities such as security protocols (e.g., WPA2, WPA3, etc.), and/or encryption methods (e.g., advanced encryption standard (AES), or temporary key integrity protocol (TKIP), etc.) of the wireless device 310. Based on the security capabilities of the wireless device 310, the access point 320 may determine whether the wireless device 310 may meet the required security standards. If the wireless device 310 is identified as a potential security risk (e.g., lacking WPA3 support, or outdated firmware, etc.), or if the wireless device 310 is a type of device that requires special handling (e.g., an IoT device), the access point 320 may create the virtual access point 330 that may require higher security. For example, the access point 320 may use stronger encryption methods (e.g., AES) to protect data, employ authentication mechanisms (e.g., extensible authentication protocol (EAP)) to verify users and devices, and/or implement effective key management to maintain secure communications.

As described herein, the computing device 340 may send, to the access point 320, an SSID of a virtual access point associated with a certain type of wireless device. As described with respect to FIG. 4, the wireless device 310 may send, to the access point 320, the probe request message 403 comprising the type of the wireless device 310.

Upon receiving the probe request message 403 comprising the type of the wireless device 310, the access point 320 may determine whether the access point 320 has received the same type of wireless device from the computing device 340. The access point 320 may create a virtual access point 330 (as 404 in FIG. 4) if the type contained in the probe request message 403 corresponds to (or matches) the type sent by the computing device 340 (e.g., via the configuration information message 401). If the virtual access point 330 is created by the access point 320, the virtual access point 330 may broadcast beacon messages.

The access point 320 may cause the wireless device 310 to connect to the virtual access point 330. For example, if the virtual access point 330 may send a probe response message 405 to the wireless device 310, the access point 320 may determine that the wireless device 310 is successfully connected to the virtual access point 330 (as 406 in FIG. 4).

Optionally, in some embodiments, the computing device 340 may either deny or allow the onboarding of specific wireless devices, for example, depending on the specific design and/or requirements of the wireless network. For example, the computing device 340 may send, to the access point 320, the configuration information message 401 containing MAC addresses of the specific wireless devices. If the MAC address of the wireless device 310, contained in the probe request 403, is one of the MAC addresses sent by the computing device 340 (e.g., via the configuration information message 401), the access point 320 may either deny or allow the wireless device 310.

In various embodiments, the wireless device 310 may have a pre-set (or built-in) password for the SSID of the virtual access point 330 for onboarding and/or provisioning purposes, for example, from the time of manufacturing. The wireless device 310 may receive, from the virtual access point 330, the beacon message that may comprise the SSID of the virtual access point 330. Using the SSID and the pre-set (or built-in) password of the virtual access point 330, the wireless device 310 may automatically connect to the virtual access point 330. For example, for authentication purposes, the wireless device 310 may send the SSID and password of the virtual access point 330, the MAC address of the wireless device 310, and/or other relevant information to the computing device 340

For a secure connection, the wireless device 310 may exchange security elements (e.g., cryptographic keys, authentication details such as digital certificates, etc.) with a computing device 340 via the virtual access point 330 (as 407 as shown in FIG. 4). The virtual access point 330 may act as an intermediary in the communication between the wireless access point 330 and the computing device 340. The goal of exchanging the security elements is to establish a secure and encrypted connection between the wireless device 310 and the computing device 340. The computing device 340 may validate the wireless device 310, for example, based on the type of the wireless device 310, the MAC address of the wireless device 310, the received security elements, and/or any other information relating to the credentials of the wireless device 310. The validation may ensure that the wireless device 310 is authorized and trusted for secure and authenticated communications with the computing device 340.

Based on validating the wireless device 310, the computing device 340 may send, to the wireless device 310, the SSID and password of the access point 320 (as 408 shown in FIG. 4). After receiving the SSID and password of the access point 320 from the computing device 340, the wireless device 310 may disconnect from the virtual access point 330 (as 409 shown in FIG. 4), for example, by sending a disassociation message to the virtual access point 330. Using the received password of the access point 320, the wireless device 310 may connect to the access point 320. (as 410 shown in FIG. 4), for example, after the disconnection from the virtual access point 330. The access point 320 may destroy the virtual access point 330 (as 411 shown in FIG. 4), for example, if the access point 320 no longer receives any additional probe request messages containing the SSID of the virtual access point 330 for a pre-determined amount of time. The wireless device 310 may remain connected to the access point 320, for example, until the wireless device 301 may disconnect from the wireless access point 320 (e.g., by sending a disassociation message to the virtual access point 330).

The access point 320 may create a different virtual access point based on receiving a different probe request message containing a different type of wireless device, for example, after destroying the virtual access point 330. For example, if a different type of wireless device (not shown in FIG. 4) sends, to the access point 320, a probe request message indicating a different type of wireless device, the access point 320 may check if the type of the wireless device indicated in the probe request message corresponds to one of the wireless device types sent from a different computing device (not shown in FIG. 4).

If the type of the wireless device indicated in the different probe request message sent from the different type of wireless device corresponds to one of the wireless device types sent from the different computing device, the wireless access point 320 may create a different virtual access point dedicated to the different type of wireless device. After the different virtual access point is created, the similar procedures (as described above) may be performed by the different type of wireless device, the wireless access point 320, the different virtual access point, the different computing device to onboard and provision the different type of wireless device.

A use case of not successfully onboarding with the access point may involve several scenarios such as incorrect credentials, weak signal strength, outdated firmware, incompatible security settings, and/or any other reasons. This may result in the wireless device being unable to connect to the network. Resetting passwords, moving closer to the access point, updating device software, adjusting the network's security settings, and/or any other troubleshooting steps may be considered to resolve connectivity issues.

A use case of unsuccessful onboarding with the access point may involve scenarios such as incorrect credentials, weak signal strength, outdated firmware, incompatible security settings, and/or any other reasons. These issues may prevent the wireless device from connecting to the network of the access point. To resolve connectivity problems, steps such as resetting passwords, moving closer to the access point, updating the device's software, and/or adjusting the network's security settings may be used.

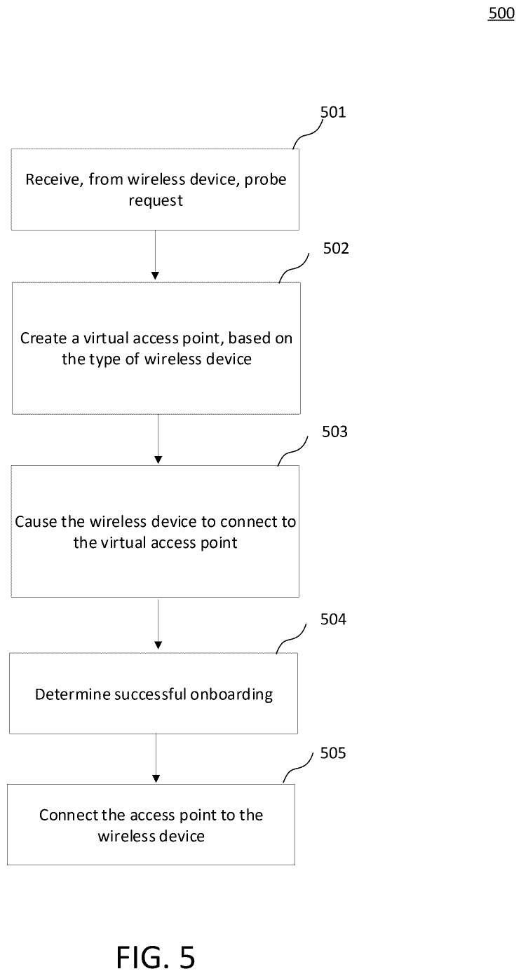

FIG. 5 is a flowchart depicting an example method 500 for an access point to manage a virtual access point according to aspects of the disclosure. An access point (e.g., access point 320) may receive, from a computing device (e.g., computing device 340), configuration information (e.g., a configuration information message 410 shown in FIG. 4). For example, the configuration information message 401 may comprise at least one SSID of a virtual access point associated with a type of wireless device.

Additionally, the configuration information message 401 may further comprise at least one parameter relating to wireless network security (e.g., key management methods, encryption algorithms, authentication mechanisms, and/or any other security-related parameters) associated with the virtual access point 330. The access point 320 may use the at least one parameter, for example, to make the virtual access point 330 safer and more secure.

In some embodiments, the configuration information message 401 may comprise at least one MAC address of at least one wireless device (e.g., wireless device 310). The access point 320 may use the at least one MAC address, for example, to either reject or allow at least one wireless device to connect.

Upon receiving the configuration information (e.g., a configuration information message 410 shown in FIG. 4), the access point (e.g., access point 320) may send an acknowledgement message (e.g., acknowledgement message 402 shown in FIG. 4) to the computing device (e.g., computing device 340). In Wi-Fi network, an acknowledgement message is a frame used to confirm the receipt of a data frame. The acknowledgement message may include frame control, duration, receiver address, and/or frame check sequence.

At 501, the access point (e.g., access point 320) may receive a probe request message (e.g., probe request message 403) from a wireless device (e.g., wireless device 310). For onboarding and provisioning purposes, the wireless device (e.g., wireless device 310) may send a probe request message (e.g., probe request message 403) comprising the type (e.g., Wi-Fi extender, or security camera, etc.) of the wireless device (e.g., wireless device 310).

Furthermore, the probe request message (e.g., probe request message 403) may further comprise information relating to the security capabilities (e.g., supported encryption and/or authentication methods) of the wireless device (e.g., wireless device 310). Upon receiving the probe request message 403, which comprises the type and security capabilities of the wireless device 310, the access point 320 may assess the type of the wireless device 310 and determine whether the wireless device 310 has any security risks. For example, Internet of Things (IoT) devices may be considered higher risk due to factors such as less frequent updates and/or inherent vulnerabilities. The access point 320 may evaluate the security capabilities such as security protocols (e.g., WPA2, WPA3, etc.), and/or encryption methods (e.g., advanced encryption standard (AES), or temporary key integrity protocol (TKIP), etc.) of the wireless device 310. Based on the security capabilities of the wireless device 310, the access point 320 may determine whether the wireless device 310 may meet the required security standards. If the wireless device 310 is identified as a potential security risk (e.g., lacking WPA3 support, or outdated firmware, etc.), or if the wireless device 310 is a type of device that requires special handling (e.g., an IoT device), the access point 320 may create the virtual access point 330 that may require higher security. For example, the access point 320 may use stronger encryption methods (e.g., AES) to protect data, authentication mechanisms (e.g., extensible authentication protocol (EAP)) to verify users and devices, and/or effective key management to maintain secure communications.

At 502, the access point (e.g., access point 320) may create, based on the type of the wireless device (e.g., wireless device 310) indicated in the probe request message (e.g., probe request message 403), a virtual access point (e.g., virtual access point 330) dedicated to the wireless device (e.g., wireless device 310). Upon being created, the virtual access point (e.g., virtual access point 330) may broadcast beacon messages. Additionally, based on the information relating to the security capabilities (e.g., supported encryption and/or authentication methods) of the wireless device (e.g., wireless device 310) indicated in the probe request message (e.g., probe request message 403), the access point (e.g., access point 320) may enhance the security of the virtual access point (e.g., virtual access point 330).

At 503, the access point (e.g., access point 320) may cause the wireless device (e.g., wireless device 310) to connect to the virtual access point (e.g., virtual access point 330). At 504, the access point (e.g., access point 320) may determine that the wireless device (e.g., wireless device 310) is successfully connected to the virtual access point (e.g., virtual access point 330), for example, if the virtual access point (e.g., virtual access point 330) may send a probe response message 405 to the wireless device (e.g., wireless device 310).

At 505, the access point (e.g., access point 320) may connect to the wireless device (e.g., wireless device 310), for example, if the access point (e.g., access point 320) may receive, from the wireless device (e.g., wireless device 310), information associated with the access point (e.g., access point 320) (e.g., password of the access point). For example, the information associated with the access point (e.g., password of the access point) may be sent, from a computing device (e.g., computing device 340), to the wireless device (e.g., wireless device 310) via the virtual access point (e.g., virtual access point 330).

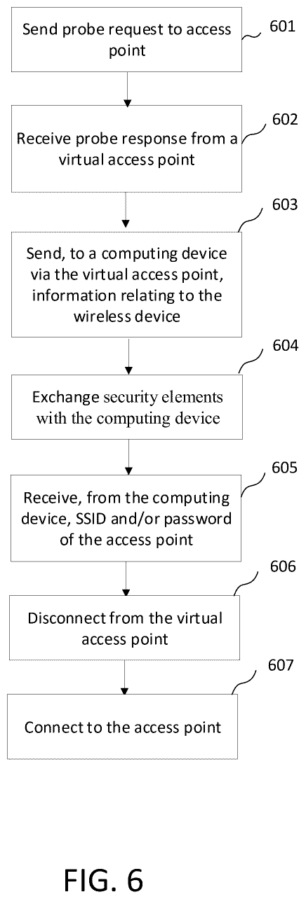

FIG. 6 is a flowchart depicting an example method 600 for a wireless device to be onboarded and provisioned according to aspects of the disclosure. For example, at 601, a wireless device (e.g., wireless device 310) may send a probe request message (e.g., probe request message 403) to an access point (e.g., access point 320). For example, the probe request (e.g., probe request message 403) may comprise the type of the wireless device (e.g., wireless device 310). Furthermore, the probe request (e.g., probe request message 403) may further comprise information relating to the security capabilities such as security protocols (e.g., WPA2, WPA3, etc.), and/or encryption methods (e.g., advanced encryption standard (AES), or temporary key integrity protocol (TKIP), etc.) of the wireless device (e.g., wireless device 310).

At 602, after the wireless device (e.g., wireless device 310) sends the probe request message (e.g., probe request message 403) to the access point (e.g., access point 320), the access point (e.g., access point 320) may create a virtual access point (e.g., virtual access point 330). The access point (e.g., access point 320) may cause the wireless device (e.g., wireless device 310) to connect to the virtual access point (e.g., virtual access point 330). If the wireless device (e.g., wireless device 310) is connected to the virtual access point (e.g., virtual access point 330), the wireless device (e.g., wireless device 310) may receive a probe response message from the virtual access point (e.g., virtual access point 330). For example, the probe response message may indicate that the wireless device (e.g., the wireless device 310) is successfully connected to the virtual access point (e.g., virtual access point 330).

At 603, the wireless device (e.g., the wireless device 310) may send, to a computing device (e.g., computing device 340) via the virtual access point (e.g., virtual access point 330), information relating to at least one parameter of the wireless device (e.g., the wireless device 310). The information may comprise the type of the wireless device (e.g., the wireless device 310), the security capabilities such as security protocols (e.g., WPA2, WPA3, etc.), encryption methods (e.g., advanced encryption standard (AES), or temporary key integrity protocol (TKIP), etc.) of the wireless device (e.g., the wireless device 310), the MAC address of the wireless device (e.g., the wireless device 310), and/or any credential information of the wireless device (e.g., the wireless device 310).

At 604, the wireless device (e.g., the wireless device 310) may exchange security elements (e.g., cryptographic keys, authentication details such as digital certificates, etc.) with the computing device (e.g., computing device 340) via the virtual access point (e.g., virtual access point 330). The goal of exchanging the security elements is to establish a secure and encrypted connection between the wireless device 310 and the computing device 340.

At 605, the wireless device (e.g., the wireless device 310) may receive, from the computing device (e.g., computing device 340) via the virtual access point (e.g., virtual access point 330), information associated with the access point (e.g., access point 320). The information associated with the access point (e.g., access point 320) may comprise the SSID and/or the password of the access point (e.g., access point 320).

At 606, after receiving the information associated with the access point (e.g., the password of the access point), the wireless device (e.g., the wireless device 310) may disconnect from the virtual access point (e.g., virtual access point 330). At 607, the wireless device (e.g., the wireless device 310) may connect to the access point (e.g., access point 320) by using the information associated with the access point (e.g., the password of the access point).

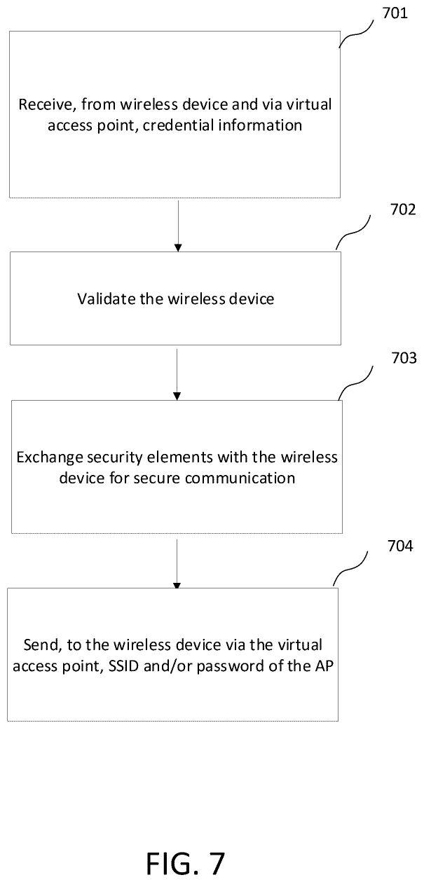

FIG. 7 is a sequence diagram depicting an example method 700 for a computing device to onboard and provision a wireless device according to aspects of the disclosure. For example, a computing device (e.g., computing device 340) may send, to an access point (e.g., access point 320), a configuration information message (e.g., configuration information message 401). The computing device (e.g., computing device 340) may inform the access point (e.g., access point 320) that a certain type of wireless device may correspond to a specific virtual access point. For example, a type 1 wireless device corresponds to virtual access point 1, a type 2 wireless device corresponds to virtual access point 2, . . . , and a type N wireless device corresponds to virtual access point N. Each virtual access point may have its own SSID. For example, virtual access point 1 has SSID 1, virtual access point 2 has SSID 2, . . . , virtual access point N has SSID N.

The configuration information message (e.g., configuration information message 401) may comprise at least one SSID of a virtual access point associated with a type of wireless device. The configuration information message 401 may further comprise the password for the at least one SSID.

Additionally, the configuration information message (e.g., configuration information message 401) may further comprise at least one parameter relating to wireless network security (e.g., key management methods, encryption algorithms, authentication mechanisms, and/or any other security-related parameters) associated with the virtual access point (e.g., virtual access point 330). For example, the access point (e.g., access point 320) may use the at least one parameter, for example, to enhance the safety and security of the virtual access point (e.g., virtual access point 330).

In some embodiments, the configuration information message 401 may comprise at least one media access control (MAC) address of at least one wireless device (e.g., wireless device 310). The access point 320 may use the at least one MAC address, for example, to either reject or allow at least one wireless device to connect.

After sending the configuration information message (e.g., configuration information message 401), the computing device (e.g., computing device 340) may receive an acknowledgement message (e.g., acknowledgement message 402) from the access point (e.g., access point 320). In Wi-Fi network, an acknowledgement message is a frame used to confirm the receipt of a data frame. For example, if a Wi-Fi enabled device successfully receives a data frame from a sender, the Wi-Fi enabled device sends an acknowledgment message back to the sender.

At 701, the computing device (e.g., computing device 340) may receive, from a wireless device (e.g., wireless device 310) via a virtual access point (e.g., virtual access point 330), credential information. The credential information may comprise, for example, the type of the wireless device 310, the MAC address of the wireless device 310, and/or any other information relating to the credentials of the wireless device (e.g., wireless device 310).

At 702, the computing device (e.g., computing device 340) may validate the wireless device (e.g., wireless device 310), for example, based on the received credential information. The validation may ensure that the wireless device (e.g., wireless device 310) is authorized and trusted for secure and authenticated communications with the computing device 340.

At 703, the computing device (e.g., computing device 340) may establish a secure communication with the wireless device (e.g., wireless device 310). For example, the computing device (e.g., computing device 340) may exchange security elements (e.g., cryptographic keys, authentication details such as digital certificates, etc.) with the wireless device (e.g., wireless device 310) via the virtual access point (e.g., virtual access point 330). The goal of exchanging the security elements is to establish a secure and/or encrypted connection between the wireless device 310 and the computing device 340.

At 704, the computing device (e.g., computing device 340) may send, to the wireless device (e.g., wireless device 310) via the virtual access point (e.g., virtual access point 330), an SSID and/or a password of the access point (e.g., access point 320). For example, the wireless device (e.g., wireless device 310) may use the SSID and the password to connect to the access point (e.g., access point 320).

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

What is claimed is:

1. A method comprising:
receiving, by an access point and from a wireless device, a message indicating a type of the wireless device;
creating, based on the type of the wireless device, a virtual access point corresponding to the wireless device;
causing the wireless device to connect to the virtual access point;
determining whether the wireless device is connected to the virtual access point; and
connecting the access point to the wireless device.

2. The method of claim 1, wherein the message comprises information relating to security associated with the wireless device.

3. The method of claim 1, further comprising:
receiving, from the wireless device, information relating to security associated with the wireless device,
wherein the creating the virtual access point further comprises creating, based on the information, the virtual access point.

4. The method of claim 1, wherein the determining is based on a response message sent from the virtual access point to the wireless device.

5. The method of claim 1, further comprising receiving, from a computing device, information relating to the virtual access point, wherein the information comprises a service set identifier of the virtual access point.

6. The method of claim 1, further comprising destroying, after creating the virtual access point, the virtual access point, wherein the destroying the virtual access point is based on receiving no additional messages from at least one wireless device for a pre-determined amount of time.

7. The method of claim 1, further comprising determining, based on a media access control address of the wireless device, whether to allow the wireless device to connect to the virtual access point.

8. The method of claim 1, further comprising receiving, from a computing device, at least one media access control address of at least one wireless device.

9. The method of claim 1, the connecting is based on receiving, from the wireless device, information associated with the access point.

10. The method of claim 1, wherein the message further comprises information relating to at least one parameter of the wireless device.

11. A method comprising:
sending, by a wireless device and to an access point, at least one message, wherein the at least one message comprises a type of the wireless device;
receiving, from a virtual access point, a response message, wherein the response message indicates that the wireless device is connected to the virtual access point;
sending, to a computing device and via the virtual access point, information relating to at least one parameter of the wireless device;
receiving, from the computing device and via the virtual access point, information associated with the access point; and
connecting, based on receiving the information associated with the access point, the wireless device to the access point.

12. The method of claim 11, wherein the information associated with the access point comprises a service set identifier and a password of the access point.

13. The method of claim 11, wherein the at least one message comprises a media access control address of the wireless device.

14. The method of claim 11, wherein the information relating to at least on parameter of the wireless device comprises credential information associated with the wireless device.

15. The method of claim 11, further comprising disconnecting, after receiving the information associated with the access point, from the virtual access point.

16. A method comprising:
receiving, by a computing device and from a wireless device via a virtual access point, at least one parameter of the wireless device;
determining, based on receiving the at least one parameter from the wireless device, whether the wireless device is associated the access point; and
sending, to the wireless device and via the virtual access point, information associated with the access point.

17. The method of claim 16, wherein the information associated with the access point comprises a service set identifier and a password of the access point.

18. The method of claim 16, further comprising sending, by the computing device and to the access point, information relating to parameters of at least one virtual access point, wherein the information relating to the parameters of the virtual access point comprises a service set identifier of the at least one virtual access point.

19. The method of claim 16, further comprising establishing a secure connection for communication with the wireless device.

20. The method of claim 16, further comprising receiving, from the access point, an acknowledgment message, based on sending information relating to parameters of at least one virtual access point.
